(19) United States
(12) Patent Application Publication
(10) Pub. No.: US 2025/0136102 A1
(43) Pub. Date: May 1, 2025

(54) VEHICLE CONTROL DEVICE, NON-TRANSITORY COMPUTER-READABLE STORAGE MEDIUM, AND VEHICLE CONTROL METHOD

(71) Applicant: Mitsubishi Electric Corporation, TOKYO (JP)

(72) Inventors: Masahiro ABUKAWA, Tokyo (JP); Naoyuki TSUSHIMA, Tokyo (JP)

(73) Assignee: Mitsubishi Electric Corporation, TOKYO (JP)

(21) Appl. No.: 19/010,704

(22) Filed: Jan. 6, 2025

Related U.S. Application Data
(63) Continuation of application No. PCT/JP2022/030232, filed on Aug. 8, 2022.

(51) Int. Cl. B60W 30/09; B60W 30/095; B60W 50/00; G06V 20/56

(52) U.S. Cl. CPC B60W 30/09; B60W 30/0956; B60W 50/0097; G06V 20/588; B60W 2050/0029; B60W 2420/403; B60W 2540/22

(57) ABSTRACT

A vehicle control unit includes: a sensor-signal processing unit that acquires sensor signals from multiple sensors detecting physical quantities related to the surrounding environment of a vehicle and acquires, from at least one camera capturing images of the surrounding of the vehicle, image data indicating the captured images; a human-vision calculating unit that uses a human visual model calculated in advance calculates a visibility repulsive potential affected by vision of a human recognizing the images; and a potential-risk-prediction-model processing unit that uses a potential-risk prediction model for predicting a potential risk from characteristic quantities of the surrounding environment of a target vehicle to calculate a physical repulsive potential caused by the surrounding environment of the target vehicle on the basis of the physical quantities and the images, and calculates an integrated repulsive potential obtained by correcting the physical repulsive potential with the visibility repulsive potential.

### CROSS REFERENCE TO RELATED APPLICATION

This application is a continuation application of International Application No. PCT/JP2022/030232 having an international filing date of Aug. 8, 2022.

### BACKGROUND OF THE INVENTION

### 1. Field of the Invention

The disclosure relates to a vehicle control device, a non-transitory computer-readable storage medium, and a vehicle control method.

### 2. Description of the Related Art

In recent years, techniques related to autonomous driving of vehicles have been developed. The basic techniques for driving vehicles are cognition, judgment, and manipulation. Judgment is to process complicated combinations of traffic participants of an unspecified number. In relation to such judgment, traveling control for performing routing and control of a vehicle is well-studied.

As routing and control of a vehicle, an artificial potential method described in PTL 1 (also referred to as a potential field method) is often applied. The artificial potential method is based on the idea that the human sense of danger is expressed in vehicle behavior and basically provides control using a physical vehicle control model.
Patent Literature 1: Japanese Patent Application Publication No. 2018-192954

### SUMMARY OF THE INVENTION

However, conventional vehicle control through the artificial potential method does not necessarily coincide with vehicle control by a passenger's recognition, judgment, and manipulation through perception, and thus, there is a problem that comfortable boarding is not possible.

Accordingly, an object of one or more aspects of the disclosure is to perform autonomous driving of a vehicle so as to reduce a passenger's discomfort.

A vehicle control device according to an aspect of the disclosure includes: processing circuitry to acquire sensor signals from a plurality of sensors detecting a physical quantity related to a surrounding environment of a vehicle; an image-data acquiring unit configured to acquire image data indicating images of surroundings of the vehicle from at least one camera capturing the images; to use a potential-risk prediction model learned in advance to predict a potential risk from a characteristic quantity of the surrounding environment of a target vehicle, to calculate a physical repulsive potential based on the physical quantity and the images, the physical repulsive potential being a repulsive potential caused by the surrounding environment of the vehicle; to use a human visual model calculated in advance, to calculate a visibility repulsive potential, the visibility repulsive potential being a repulsive potential affected by vision of a human recognizing the images; to calculate an integrated repulsive potential obtained by correcting the physical repulsive potential with the visibility repulsive potential; to generate a target path to cause the vehicle to travel from a current position of the vehicle to a target point in accordance with a gradient calculated from the integrated repulsive potential; and to control the vehicle to cause the vehicle to travel along the target path.

According to one or more aspects of the disclosure, autonomous driving of a vehicle can be performed so as to reduce a passenger's discomfort.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram illustrating the main configuration of a vehicle control system mounted on an autonomously driving vehicle;

FIG. 2 is a block diagram schematically illustrating the configuration of a human-vision calculating unit and a potential-risk-prediction-model processing unit;

FIG. 3 is a schematic diagram illustrating an example of the surrounding environment of a vehicle on which the vehicle control system is mounted; and

FIGS. 4A and 4B are block diagrams illustrating hardware configuration examples.

### DETAILED DESCRIPTION OF THE INVENTION

### First Embodiment

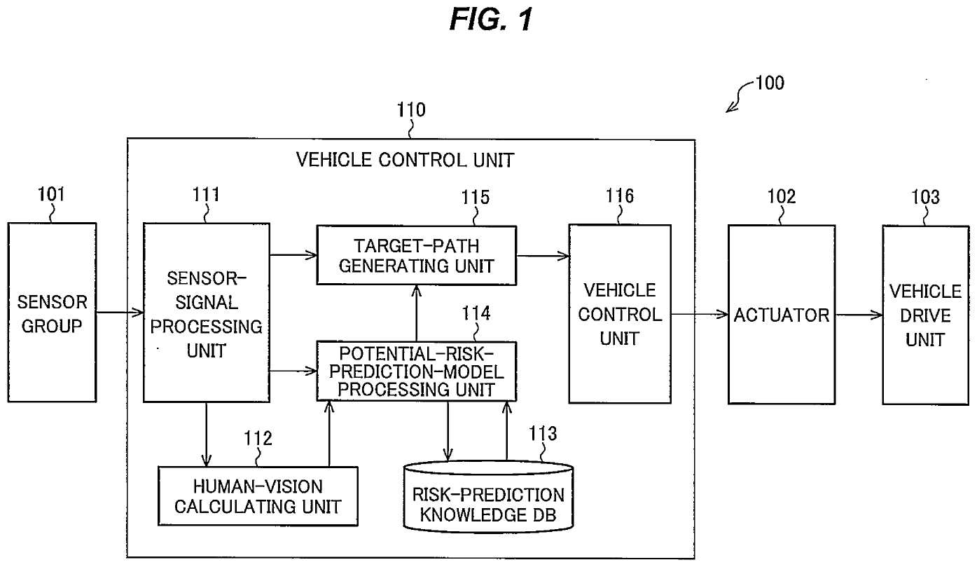

FIG. 1 is a block diagram illustrating the main configuration of a vehicle control system 100 mounted on an autonomously driving vehicle.

The vehicle control system 100 includes a sensor group 101, a vehicle control unit 110, an actuator 102, and a vehicle drive unit 103.

The sensor group 101 includes multiple sensors that detect physical quantities related to the surrounding environment of the vehicle.

The sensor group 101 includes one or more cameras that function as an imaging unit that captures images of the surroundings of the vehicle. Image data indicating the captured images is given to the vehicle control unit 110.

Here, the sensor group 101 includes an ambient sensor that detects people and obstacles around the vehicle. For example, the sensor group 101 includes at least one of a high frequency radar sensor, an ultrasound sensor, and a LiDAR. The ambient sensor gives sensor signals indicating the detected content to the vehicle control unit 110.

The sensor group 101 includes a vehicle sensor that detects the manipulation state and behavior of the vehicle on which the vehicle control system 100 is mounted. For example, the sensor group 101 includes at least one of a vehicle speed sensor, an acceleration sensor, and an angular speed sensor. The sensor group 101 includes, for example, at least one of an accelerator position sensor, a brake stroke sensor, a brake pressure sensor, a rudder angle sensor, an engine speed sensor, a brake lamp switch, and an indicator switch. The vehicle sensors give sensor signals indicating the detected content to the vehicle control unit 110.

The sensor group 101 includes a global positioning system (GPS) receiver that functions as a GPS receiving unit including a GPS antenna for receiving GPS signals. The received GPS signals are given to the vehicle control unit 110.

The vehicle control unit 110 functions as a vehicle control device that controls a vehicle on which the vehicle control system 100 is mounted.

The vehicle control unit 110 includes a sensor-signal processing unit 111, a human-vision calculating unit 112, a risk-prediction knowledge database (hereinafter, referred to as a risk-prediction knowledge DB) 113, a potential-risk-prediction-model processing unit 114, a target-path generating unit 115, and a vehicle control unit 116.

The sensor-signal processing unit 111 acquires various signals and data from the sensor group 101, executes signal processing such as analog-to-digital conversion, if required, and gives the processed signals and data to the subsequent components.

For example, the sensor-signal processing unit 111 functions as an image-data acquiring unit that acquires image data from the one or more cameras. The sensor-signal processing unit 111 gives the image data to the human-vision calculating unit 112 and the potential-risk-prediction-model processing unit 114.

The sensor-signal processing unit 111 also functions as a sensor-signal acquiring unit that acquires sensor signals from the vehicle sensors, the ambient sensor, and the GPS receiver.

The sensor-signal processing unit 111 gives the sensor signals from the vehicle sensors to the potential-risk-prediction-model processing unit 114. The sensor-signal processing unit 111 gives the sensor signals from the ambient sensor and the GPS signals, or sensor signals, from the GPS receiver to the target-path generating unit 115.

The human-vision calculating unit 112 uses a human visual model that has been mathematically modeled in advance to calculate a visibility repulsive potential that represents the recognition of an image indicated by the image data as repulsive potential energy affected by the vision of a human. The calculated visibility repulsive potential is given to the potential-risk-prediction-model processing unit 114.

For example, somatological or psychophysical human visual models include a lateral inhibition model in which optic nerve cells inhibit the surrounding cells simultaneously with stimulation such as brightness, a motion perception model of an optical flow, an apparent motion, or the like, and a color vision model; and such portions of models are mathematically modeled. The human-vision calculating unit 112 calculates a psychological potential field from such a mathematical model and uses it as a visibility repulsive potential.

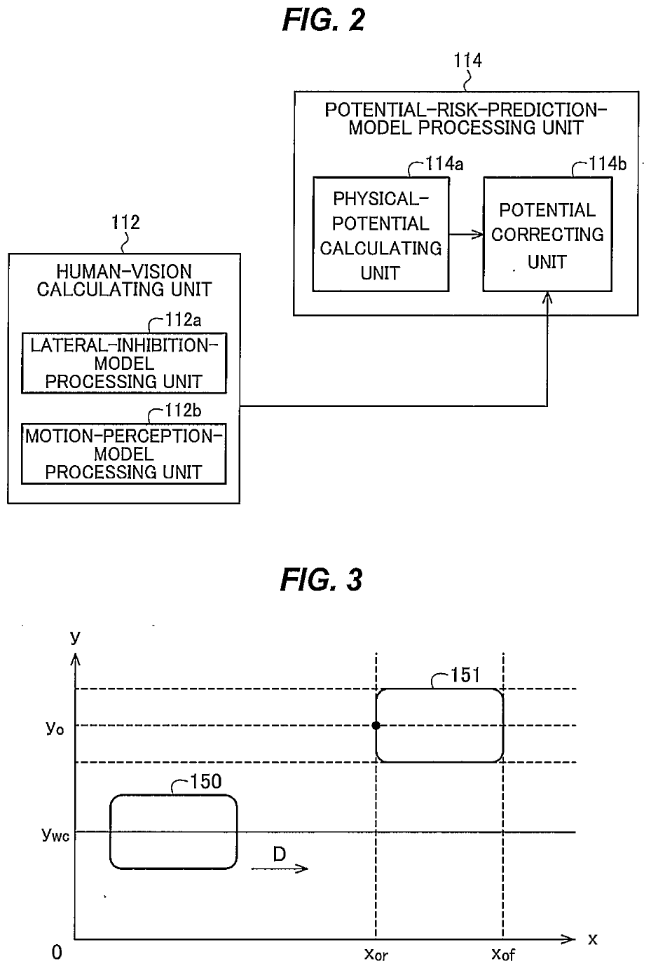

FIG. 2 is a block diagram schematically illustrating the configuration of the human-vision calculating unit 112 and the potential-risk-prediction-model processing unit 114.

The human-vision calculating unit 112 includes a lateral-inhibition-model processing unit 112a and a motion-perception-model processing unit 112b.

The lateral-inhibition-model processing unit 112a uses a lateral inhibition model as a visual model to calculate a psychological potential as the visibility repulsive potential.

For example, the lateral-inhibition-model processing unit 112a uses the lateral inhibition model, which mathematically models human lateral inhibition, to calculate a psychological repulsive potential that affects the ability of discovering an obstacle by human lateral inhibition as at least a portion of the visibility repulsive potential.

According to the lateral inhibition model, when the same stimulation of the same intensity is applied to the central and peripheral portions of the receptive field, the peripheral portion inhibits the central portion, and when the stimulation applied to the central and peripheral portions differ in intensity, the difference is enhanced by lateral inhibition, and contour and contrast enhancement is affected. Therefore, lateral inhibition is thought to affect the driver's ability to detect obstacles.

Here, the lateral inhibition model described in the following Literature 1 is used as a reference from a bioengineering viewpoint.

Literature 1: Katsuhiko Fujii, Akira Matsuoka, Tatsuya Morita, “Analysis of the Optical Illusion by Lateral Inhibition,” Japanese Journal of Medical Electronics and Biological Engineering, Vol. 5, Issue 2, pp. 25-34, 1967

The lateral inhibition model can be represented as object extraction by using Equation (1):

$$p ( x , y ) = {\int }_{- ∞}^{∞} {\int }_{- ∞}^{∞} w ( ξ - x , η - y ) i ( ξ , η ) d ξ d η \qquad ( 1 )$$

where i(ξ,η) is a stimulus figure, p(x,y) is the intensity of neural activity, and w (ξ−x, η−y) is a coupling function.

Note that x, y, ξ, and η are coordinate values on the retina, x and y are reference coordinates of p, and ξ and η are coordinates of an obstacle.

The receptive field of retinal neurons is a concentric structure and can be approximated by a difference of Gaussian (DOG) function, as represented by Equation (2), if the coupling function is considered as a spatial property:

$$w ( x , y ) {\sum }_{i = 1}^{2} \frac{{K}_{i}}{2 {πσ}_{i}^{2}} exp ( - \frac{{x}^{2} + {y}^{2}}{2 {σ}_{i}^{2}} ) \qquad ( 2 )$$

where K₁ is a coefficient indicating the strength of excitatory coupling, K₂ is a coefficient indicating the strength of inhibitive coupling, σ₁ is the variance of excitability, and σ₂ is the variance of inhibitive coupling.

On the basis of the above, a psychological potential Uₚ is calculated using Equation (3), if the output p(x,y) is the psychological potential Uₚ for an object shape:

$${U}_{p} = p ( x , y ) = {\sum }_{i = 1}^{2} \frac{{K}_{i}}{2 {πσ}_{i}^{2}} {\int }_{- ∞}^{∞} {\int }_{- ∞}^{∞} exp [ - \frac{1}{2 {σ}_{i}^{2}} \{ {( ξ - x )}^{2} + {( η - y )}^{2} \} ] \cdot i ( ξ , η ) d ξ d η \qquad ( 3 )$$

In Equation (3), i(ξ,η) is a stimulus figure and its effect can be regarded as an obstacle shape when it is treated as a high-order color vision mechanism of color vision and as a binary image. Therefore, it can be considered as a constant integral, and Equation (4) is obtained as the following:

$${U}_{p} = {\sum }_{i = 1}^{2} \frac{{K}_{i}}{2 {πσ}_{i}^{2}} {\int }_{{ξ}_{1}}^{{ξ}_{2}} {\int }_{{η}_{1}}^{{η}_{2}} exp [ - \frac{1}{2 {σ}_{i}^{2}} \{ {( ξ - x )}^{2} + {( η - y )}^{2} \} ] d ξ d η \qquad ( 4 )$$

Accordingly, the lateral-inhibition-model processing unit 112a uses Equation (4) to calculate the psychological potential Uₚ.

The motion-perception-model processing unit 112b uses a motion perception model as a visual model to calculate a motion-perception repulsive potential as the visibility repulsive potential.

For example, the motion-perception-model processing unit 112b uses the motion perception model, which mathematically models human motion perception, to calculate the motion-perception repulsive potential that affects the ability of discovering an obstacle by human motion perception as at least a portion of the visibility repulsive potential.

Motion perception is calculated by determining optical flow, apparent motion, induced motion, etc., through models such as a detection model for the optical flow of a moving object, e.g., the Lucas-Kanade method, or a motion perception model, such as the Reichardt type model, which is a computational approach, or a gradient detection model.

In this case, if a pixel of a target object is pixel I(x,y,t), the pixel after Δt seconds is calculated using Equation (5):

$$I ( x , y , t ) = I ( x + dx , y + dy , t + Δ t ) \qquad ( 5 )$$

A constraint equation for pixel movement speed is calculated using Equations (6) and (7) by Taylor expanding Equation (5) and dividing it by dt:

$${f}_{x} u + {f}_{y} v + {f}_{t} = \frac{\partial f}{\partial x} , {f}_{y} = \frac{\partial f}{\partial x} , u = \frac{dx}{dt} , v = \frac{dy}{dt} \qquad ( 6 )$$

$${f}_{x}^{′} {u}^{′} + {f}_{y}^{′} {v}^{′} = 0 \qquad ( 7 )$$

From the above, the motion-perception repulsive potential Uₘ is calculated using Equation (8):

$${U}_{m} = m ( {f}_{x}^{′} {u}^{′} + {f}_{y}^{′} {v}^{′} ) l \qquad ( 8 )$$

where m is the mass of the moving body and l is the distance traveled.

The apparent motion and induced motion can also be calculated on the basis of the same concept as above.

Referring back to FIG. 1, a risk-prediction knowledge DB 113 stores a potential-risk prediction model.

The potential-risk prediction model is a learned model that incorporates, into a control model, repulsive potential consisting of road boundaries, stationary obstacles, and dart-out from behind the stationary obstacles, and attractive potential of a vehicle trajectory (path) toward a target site, under the concept that the human sense of danger is manifested in manipulation, as described in PTL 1, etc. The potential-risk prediction model can be generated using known techniques.

The potential-risk-prediction-model processing unit 114 corrects the physical repulsive potential, which is the repulsive potential calculated using the potential-risk prediction model stored in the risk-prediction knowledge DB 113, by using the visibility repulsive potential calculated by the human-vision calculating unit 112, to calculate an integrated repulsive potential.

As illustrated in FIG. 2, the potential-risk-prediction-model processing unit 114 includes a physical-potential calculating unit 114a and a potential correcting unit 114b.

The physical-potential calculating unit 114a uses the potential-risk prediction model stored in the risk-prediction knowledge DB 113 to calculate a physical repulsive potential that is a repulsive potential determined from the physical positional relationship between the vehicle on which the vehicle control system 100 is mounted and an object such as a person or an obstacle from the sensor signals from the sensor-signal processing unit 111.

Here, the physical-potential calculating unit 114a uses the potential-risk prediction model learned in advance to predict the potential risk from characteristic quantities of the surrounding environment of the target vehicle, to calculate the physical repulsive potential, which is a repulsive potential caused by the surrounding environment of the vehicle on which the vehicle control system 100 is mounted, on the basis of the physical quantities indicated by the sensor signals and the images indicated by the image data.

For example, as illustrated in FIG. 3, it is assumed that a vehicle 150 on which the vehicle control system 100 is mounted is traveling in the direction of arrow D on a straight road with walls on both sides without a lane boundary. It is also assumed that there is a vehicle 151 parked on the left shoulder of the road with respect to the vehicle 150, that the vehicle 150 is about to drive pass the right side of the vehicle 151, and that there is no other traffic participant.

In such a situation, the related repulsive potential corresponds to a road boundary and obstacle repulsion, the control model of the vehicle 150 corresponds to lateral control, and the vehicle 150 is to exhibit constant velocity linear motion.

From the limitations mentioned above, a road-boundary repulsive potential function U_{w}(x,y) is expressed by Equation (9):

$${U}_{w} ( x , y ) = {w}_{w} exp \{ 1 - \frac{{( y - {y}_{wc} )}^{2}}{2 {σ}_{w}^{2}} \} \qquad ( 9 )$$

where y_{wc} is the y-coordinate of the center of the road, w_{w} is a weight coefficient, and σ_{w} is variance.

An obstacle repulsive potential function Uₒ(x,y) is expressed by Equation (10):

$${U}_{o} ( x , y ) = \{ \begin{matrix}{w}_{o} exp ( - \frac{{( x + {x}_{or} )}^{2}}{{σ}_{ox}^{2}} - \frac{{( y + {y}_{o} )}^{2}}{{σ}_{oy}^{2}} ) ( x \leq {x}_{or} ) \\ {w}_{o} exp ( - \frac{{( y + {y}_{o} )}^{2}}{{σ}_{oy}^{2}} ) ( {x}_{or} \leq x \leq {x}_{of} ) \\ {w}_{o} exp ( - \frac{{( x + {x}_{of} )}^{2}}{{σ}_{ox}^{2}} - \frac{{( y + {y}_{o} )}^{2}}{{σ}_{oy}^{2}} ) ( x \leq {x}_{of} )\end{matrix} \qquad ( 10 )$$

where xₒᵣ is the x-coordinate of the rear of the parked vehicle 151, x_{of} is the x-coordinate of the front of the parked vehicle 151, yₒ is the y-coordinate of the center of the parked vehicle 151 in the width direction, wₒ is the weight coefficient, and σₒₓ and σ_{oy} are variance.

Equation (9) is a one-dimensional Gaussian function where the length of the wall is infinite, and equation (10) is a two-dimensional Gaussian function.

Road-boundary repulsive potential U_{w} calculated by the road-boundary repulsive potential function U_{w}(x,y) and obstacle repulsive potential Uₒ calculated by the obstacle repulsive potential function Uₒ(x,y) are given to the potential correcting unit 114b.

The potential correcting unit 114b corrects the physical repulsive potential calculated by the physical-potential calculating unit 114a by using the visibility repulsive potential calculated by the human-vision calculating unit 112, to calculate the integrated repulsive potential.

For example, the potential correcting unit 114b calculates an integrated repulsive potential Uₐ by using Equation (11):

$${U}_{a} = α {U}_{p} + {U}_{m} + {U}_{w} + {U}_{o} \qquad ( 11 )$$

Since Equation (4) is established in a coordinate system on the retina, here, α denoting magnification is provided to match the psychological potential Uₚ with the other terms, which are established in the real world. Magnification should be calculated in advance through experiments, etc.

Here, the potential correcting unit 114b adds the visibility repulsive potential to the physical repulsive potential to calculate the integrated repulsive potential; however, the integrated repulsive potential may alternatively be calculated by multiplying the physical repulsive potential by the visibility repulsive potential.

Referring back to FIG. 1, the target-path generating unit 115 generates a target path, which is a traveling path of the vehicle on which the vehicle control system 100 is mounted, from the GPS signals from the sensor-signal processing unit 111 and the integrated repulsive potential from the potential-risk-prediction-model processing unit 114.

For example, the target-path generating unit 115 generates a target path from the current position indicated by the GPS signals to a target point set by the driver of the vehicle so as to run the vehicle in accordance with a gradient calculated from the integrated repulsive potential. The generated target path is given to the vehicle control unit 116. Target path generation with a potential may be achieved by known methods, such as the method described in PTL 1 above.

Specifically, the target-path generating unit 115 uses the potential field method to calculate the gradient of the potential as a force acting on the vehicle. The target-path generating unit 115 determines a target yaw rate and a target speed with a low integrated repulsive potential on the trajectory of the vehicle a few seconds in the future.

The vehicle control unit 116 controls the vehicle on which the vehicle control system 100 is mounted so as to run the vehicle along the target path from the target-path generating unit 115.

For example, the vehicle control unit 116 generates a control signal that controls the vehicle so as to run the vehicle along the target path from the target-path generating unit 115 and gives the control signal to the actuator 102.

Specifically, the vehicle control unit 116 converts the target yaw rate determined by the target-path generating unit 115 to a target steering angle. The vehicle control unit 116 also converts the target speed determined by the target-path generating unit 115 to a torque. The vehicle control unit 116 then generates control signals indicating the resulting target steering angle and torque.

The actuator 102 operates the vehicle drive unit 103, which is a mechanism for driving a vehicle, including an engine, an accelerator, a brake, and a steering wheel, in accordance with the control signals from the vehicle control unit 116.

The vehicle drive unit 103 is a mechanism for driving a vehicle, including an engine, an accelerator, a brake, and a steering wheel.

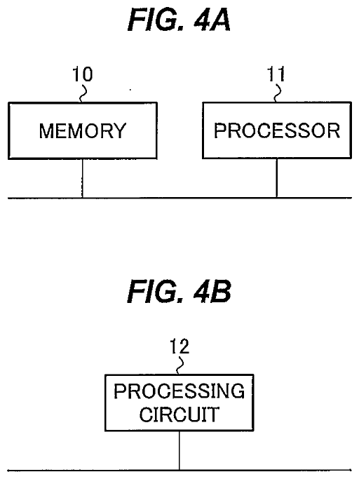

Some or all of the sensor-signal processing unit 111, the human-vision calculating unit 112, the potential-risk-prediction-model processing unit 114, the target-path generating unit 115, and the vehicle control unit 116 described above can be implemented by, for example, a memory 10 and a processor 11 such as a central processing unit (CPU) that executes the programs stored in the memory 10, as illustrated in FIG. 4A. In other words, the vehicle control device can be implemented by a computer. Such programs may be provided over a network or may be recorded and provided on a recording medium, such as a non-transitory computer-readable storage medium. That is, such programs may be provided, for example, as a program product.

Some or all of the sensor-signal processing unit 111, the human-vision calculating unit 112, the potential-risk-prediction-model processing unit 114, the target-path generating unit 115, and the vehicle control unit 116 can also be implemented by, for example, a single circuit, a composite circuit, a processor ran by a program, a parallel processor ran by a program, a processing circuit 12 such as an application specific integrated circuit (ASIC) or a field programmable gate array (FPGA), as illustrated in FIG. 4B.

As described above, the sensor-signal processing unit 111, the human-vision calculating unit 112, the potential-risk-prediction-model processing unit 114, the target-path generating unit 115, and the vehicle control unit 116 can be implemented by processing circuitry.

The risk-prediction knowledge DB 113 can be implemented by a storage device, such as a hard disc drive (HDD), a solid state drive (SDD), or a nonvolatile memory.

What is claimed is:

1. A vehicle control device comprising:
processing circuitry
to acquire sensor signals from a plurality of sensors detecting a physical quantity related to a surrounding environment of a vehicle;
to acquire image data indicating images of surroundings of the vehicle from at least one camera capturing the images;
to use a potential-risk prediction model learned in advance to predict a potential risk from a characteristic quantity of the surrounding environment of a target vehicle, to calculate a physical repulsive potential based on the physical quantity and the images, the physical repulsive potential being a repulsive potential caused by the surrounding environment of the vehicle;
to use a human visual model calculated in advance, to calculate a visibility repulsive potential, the visibility repulsive potential being a repulsive potential affected by vision of a human recognizing the images;
to calculate an integrated repulsive potential obtained by correcting the physical repulsive potential with the visibility repulsive potential;
to generate a target path to cause the vehicle to travel from a current position of the vehicle to a target point in accordance with a gradient calculated from the integrated repulsive potential; and
to control the vehicle to cause the vehicle to travel along the target path.

2. The vehicle control device according to claim 1, wherein the processing circuitry uses a lateral inhibition model mathematically modeling human lateral inhibition, to calculate a psychological repulsive potential affecting an ability of discovering an obstacle by human lateral inhibition as at least a portion of the visibility repulsive potential.

3. The vehicle control device according to claim 1, wherein the processing circuitry uses a motion perception model mathematically modeling human motion perception, to calculate a motion-perception repulsive potential affecting an ability of discovering an obstacle by human motion perception as at least a portion of the visibility repulsive potential.

4. The vehicle control device according to claim 1, wherein the processing circuitry adds or multiplies the physical repulsive potential to or by the visibility repulsive potential to correct the physical repulsive potential.

5. The vehicle control device according to claim 2, wherein the processing circuitry adds or multiplies the physical repulsive potential to or by the visibility repulsive potential to correct the physical repulsive potential.

6. The vehicle control device according to claim 3, wherein the processing circuitry adds or multiplies the physical repulsive potential to or by the visibility repulsive potential to correct the physical repulsive potential.

7. A non-transitory computer-readable storage medium storing a program that causes a computer to execute processing comprising:
acquiring sensor signals from a plurality of sensors detecting a physical quantity related to a surrounding environment of a vehicle;
acquiring image data indicating images of surroundings of the vehicle from at least one camera capturing the images;
using a potential-risk prediction model learned in advance to predict a potential risk from a characteristic quantity of the surrounding environment of a target vehicle, to calculate a physical repulsive potential based on the physical quantity and the images, the physical repulsive potential being a repulsive potential caused by the surrounding environment of the vehicle;
using a human visual model calculated in advance, to calculate a visibility repulsive potential, the visibility repulsive potential being a repulsive potential affected by vision of a human recognizing the images;
calculating an integrated repulsive potential obtained by correcting the physical repulsive potential with the visibility repulsive potential;
generating a target path to cause the vehicle to travel from a current position of the vehicle to a target point in accordance with a gradient calculated from the integrated repulsive potential; and
controlling the vehicle to cause the vehicle to travel along the target path.

8. A vehicle control method comprising:
acquiring sensor signals from a plurality of sensors detecting a physical quantity related to a surrounding environment of a vehicle;
acquiring image data indicating images of surroundings of the vehicle from at least one camera capturing the images;
using a potential-risk prediction model learned in advance to predict a potential risk from a characteristic quantity of the surrounding environment of a target vehicle, to calculate a physical repulsive potential based on the physical quantity and the images, the physical repulsive potential being a repulsive potential caused by the surrounding environment of the vehicle;
using a human visual model calculated in advance, to calculate a visibility repulsive potential, the visibility repulsive potential being a repulsive potential affected by vision of a human recognizing the images;
calculating an integrated repulsive potential obtained by correcting the physical repulsive potential with the visibility repulsive potential;
generating a target path to cause the vehicle to travel from a current position of the vehicle to a target point in accordance with a gradient calculated from the integrated repulsive potential; and
controlling the vehicle to cause the vehicle to travel along the target path.
